(19) United States
(12) Patent Application Publication
(10) Pub. No.: US 2018/0172241 A1
(43) Pub. Date: Jun. 21, 2018

(54) Love Lite

(71) Applicant: Anthony DeWayne Kallie, JR., Fayetteville, NC (US)

(72) Inventor: Anthony DeWayne Kallie, JR., Fayetteville, NC (US)

(21) Appl. No.: 15/382,638

(22) Filed: Dec. 17, 2016

(51) Int. Cl. F21V 9/16; F21V 23/04; F21L 26/00; F21V 23/00; F21V 33/00

(52) U.S. Cl. CPC F21V 9/16; F21V 23/04; F21Y 2115/10; F21V 23/001; F21V 33/0012; F21L 26/00

(57) ABSTRACT

The “Love Lite” is a black light lamp shelf that holds novelty figurines and accessories. The shelf lights the accessories from underneath and are lit by LED lighting, or like thereof. While resting on the shelf, the items absorb the fluorescent light, enabling them to be moved from the shelf and furthered enjoyed without further electricity use.

### BRIEF SUMMARY OF THE INVENTION

This invention is essentially a black light lamp shelf that holds, charges, and connects to glow in the dark accessories. The accessories would be filled, painted or molded with materials that react to fluorescent lights. The accessories or figurines that sit on the shelf would also have LED lights or some equivalent, internally housed in it. Resulting in a black light shelf the holds glow in the dark figurines that glow with added abundance when on the shelf due to the connectivity ports for the internal light sources in them.

### BRIEF DESCRIPTION OF THE DRAWINGS

FIG. 1 is a numbered drawing of the light, faced forward. Its parts as numbered are, 1. Metal conductive strip to activate the LED lights 2. Wall mount area 3. Open slit so fluorescent light can shine up and through figurine 4. Rounded smooth corners 5. Legs to stand on tables and dressers 6. Fluorescent black light lamp 7. Power Cord 8. On/Off analog switch 9. Electrical connection of light lamp to shelf. Below the numbered drawing, is a drawing of the shelf from the top. In this view you can see the grooves that provide the space for the accessories. The front groove is where the strip that activates the LED lights in each accessory. The next space is an opening to let more of the fluorescent light from the bulb itself penetrate the glowing materials inside the accessory. The groove in the back is just a shallow space, much like the front groove, but without the strip to activate the LED lights. It's there for balance mainly.

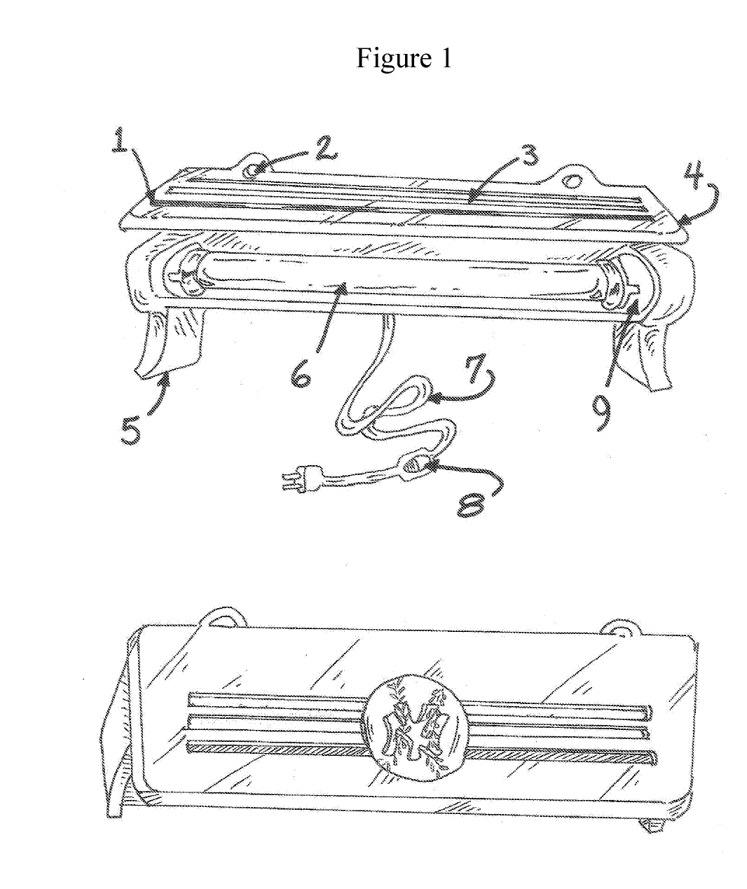

FIG. 2 is a caddy cornered view of the shelf mounted on a wall, while holding the baseball accessory. There is also a magnified image of the ball and how it is to be displayed

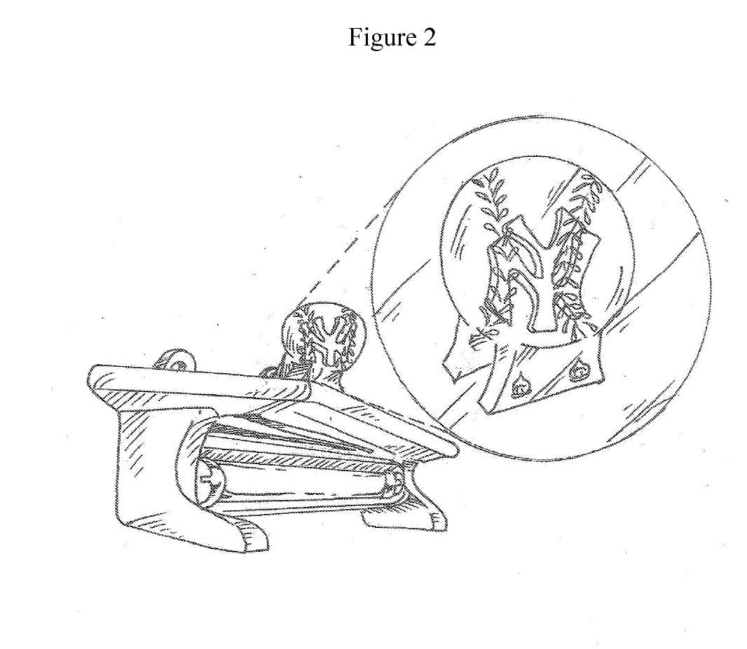

FIG. 3 is a drawing of one of the accessories for the light. This is a numbered picture of a transparent baseball, with glow in the dark threads and glowing inner logo, which is the New York Yankees symbol. At the bottom of the ball is a base so it can sit on the shelf or be balanced on flat surfaces. This drawing also displays the two LED lights in the front bottom right and left corners of the base. They will be illuminated while sitting on the shelf for added allure and multitude of color variations. The numbered parts in FIG. 3 are 1. Fluorescent glow in the dark paint or pigment 2. Colored transparent cellophane cut out of logo or symbol 3. Colored LED light

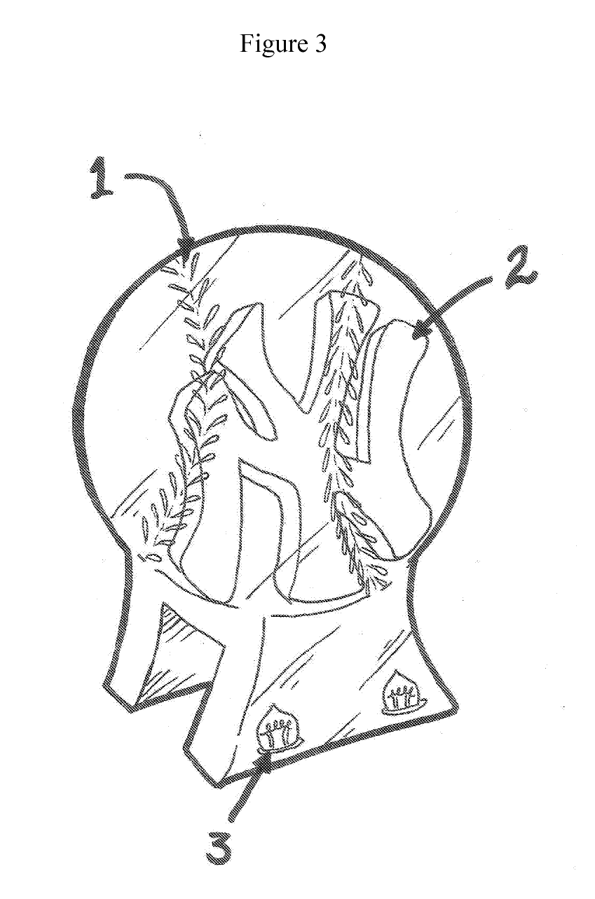

### DETAILED DESCRIPTION OF THE INVENTION

The invention would be made of transparent materials, most likely plastic or acrylic that can stand up to temperatures associated with housing a standard fluorescent light bulb. The material used, would be melted down and poured into molds, or if dealing with sheets of plastic, acrylic, or like thereof, the shelf's contours would be cut into the desired shape for assembly.

The shelf or “Love Lite” is approximately 24 inches in length and 7 inches wide. On the surface where the figurines sit, is a groove that keeps them from tipping over. In the middle of the groove are ports, or plates for an electrical point of contact that activates the LED lights in the figurines while they sit on the shelf. The shelf has places for mounting on each side, in four locations for optimum stability. I would also like the shelf to be able to be operated remotely with a duality that toggles between cutting the LED light source of so that just the fluorescent light bulb is on, and the opposite, to where you have the option of just having the accessory/figurine just lit from the internal LED lights in them.

The figurines that sit on the shelf consist of everything from zodiac signs, sports related designs, teddy bears, shapes including hearts, stars, diamonds, “adult items”, and as referenced earlier, butterflies. These figurines should be made of similar materials for compatibility, and cost efficiency. They will most likely have to be melted and poured into molds so the agents that react to fluorescent lighting can be inserted before the curing process begins. The phosphorescent materials, such as zinc sulfide, or cellophane sheets will be inserted into the figurines for added effect. These glowing agents can be cut or molded to be placed inside the design of the figurine/accessory to be seen and enjoyed while the fluorescent light bulb is burning. These materials absorb the fluorescent light, and when the fluorescent light bulb is cut off it retains its glow and gradually dims, thus creating a “nightlight” that can be moved from the shelf and placed near the bed or on a nightstand. In reference to the adult items, these would need to be hypoallergenic to enable the use of physical contact. The adult items will also have a latex, silicone, or rubber handle that attaches to the port end of the accessory to keep the connective electrical aspects of the product dry and interference-free.

For the sake of relevance, a sort of “charge” shelf should be included in the product. Made of the same material, the charge shelf would not have any of the LED or internal lighting functions, but would be just to set additional accessories on. These accessories would also glow if the fluorescent light is on due to its internal phosphorescent agents that respond to such lighting. I can also imagine needing different processes of incorporating the glowing agents into the accessories. For instance, instead of inserting the glowing materials into the figurines, for the maximum effect, I think some would have to be painted or dipped into phosphorescent paint or pigment.

1. A black light lamp, specifically made to support items such as figurines, accessories, and other types of phosphorescent, novelty items.

2. The figurines/accessories are able to be moved from the shelf and used as a nightlight, due to the nature of the glowing agents. This will save electricity because the item would maintain its glow for a period, without further use of electricity.

3. The “Love Lite” incorporates LED lighting, with fluorescent lighting in conjunction with figurines/accessories that glow with a neon effect and light up when connected to the main component.
